(19) United States
(12) Patent Application Publication
(10) Pub. No.: US 2016/0059110 A1
(43) Pub. Date: Mar. 3, 2016

(54) Laser equipped billiard cue

(71) Applicant: Michel St-Yves, St-Hubert (CA)

(72) Inventor: Michel St-Yves, St-Hubert (CA)

(21) Appl. No.: 14/841,751

(22) Filed: Sep. 1, 2015

(30) Foreign Application Priority Data
Sep. 1, 2014 (GB) 1415441.3

(51) Int. Cl. A63D 15/08; H01S 3/00

(52) U.S. Cl. CPC A63D 15/08; H01S 3/0007

(57) ABSTRACT

A laser equipped billiard cue comprising a laser emitter module, a leveling member, and battery pack. The leveling member further comprised of a pivot member and a counterweight. The level unit is being used for keeping the emitter module over the top and center of the billiard cue.

### FIELD OF THE INVENTION

The present invention relates generally to billiard equipment but more particularly to a laser equipped billiard cue.

### BACKGROUND OF THE INVENTION

Billiard is a popular activity but it requires a lot of practice in order to be good at it. Over the years, there has been ways to accelerate training by way of various training and exercises but very few pieces of equipment have been devised to help in getting better.

### SUMMARY OF THE INVENTION

In view of the foregoing disadvantages inherent in the known devices now present in the prior art, the present invention, which will be described subsequently in greater detail, is to provide objects and advantages which are:

To provide for a laser equipped aiming device for a billiard cue which draws a line on the billiard table that indicates the path of the cue ball so as to help people who are learning to play. It can also improve the game of people who have poor eyesight.

In order to do so, the invention comprises a laser emitter module, a leveling member; and battery pack. The leveling member further comprised of a pivot member and a counterweight; the level unit is being used for keeping the emitter module over the top and center of the billiard cue.

The billiard cue is separable into a plurality of parts.

Each of the plurality of parts is electrically connected to the other by way of pivot members, and each of the pivot member consisting of a fixed part and a rotating part.

The laser emitter module has an ON/OFF switch.

The laser equipped billiard cue is for use in combination with a billiard ball on a billiard table.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter which contains illustrated preferred embodiment of the invention.

### BRIEF DESCRIPTION OF THE DRAWINGS

FIG. 1a Side view of a billiard cue with the invention attached to it.

FIG. 1b Section of a billiard cue containing the invention.

FIG. 1c Interior of the billiard cue section showing the components forming part of the invention.

FIGS. 2a-c Interior of the billiard cue section showing the components forming part of the invention.

FIGS. 3a-b Top and side views of a billiard table showing the laser light pointing in a direction.

FIGS. 4a-b Top and side views of a billiard table showing the laser light pointing in a direction.

FIG. 5 See through view of the pivot.

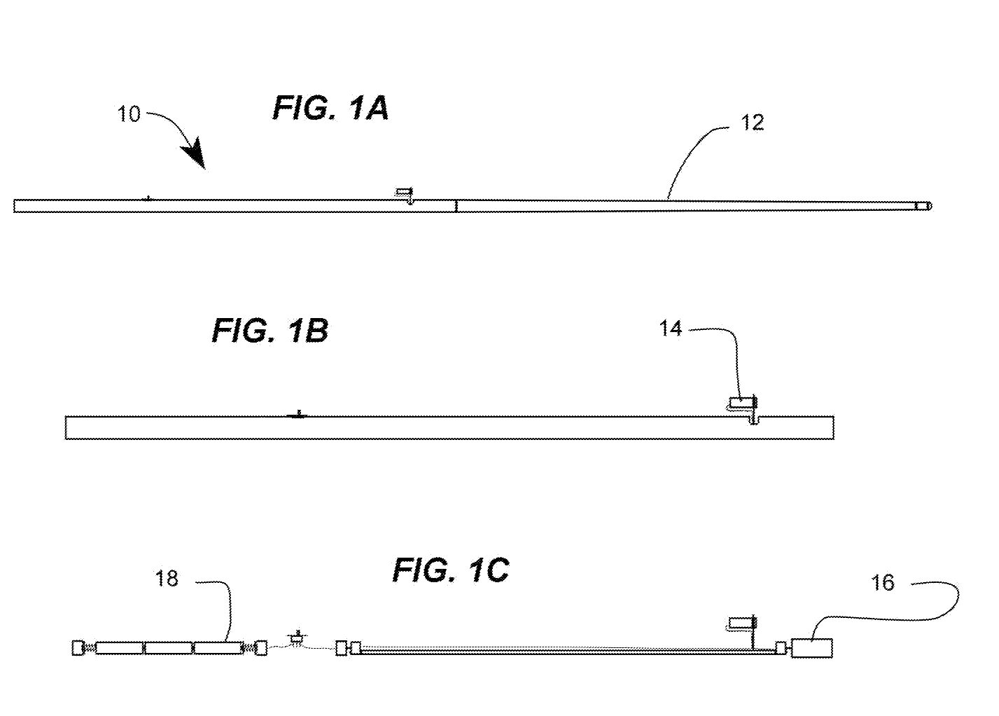

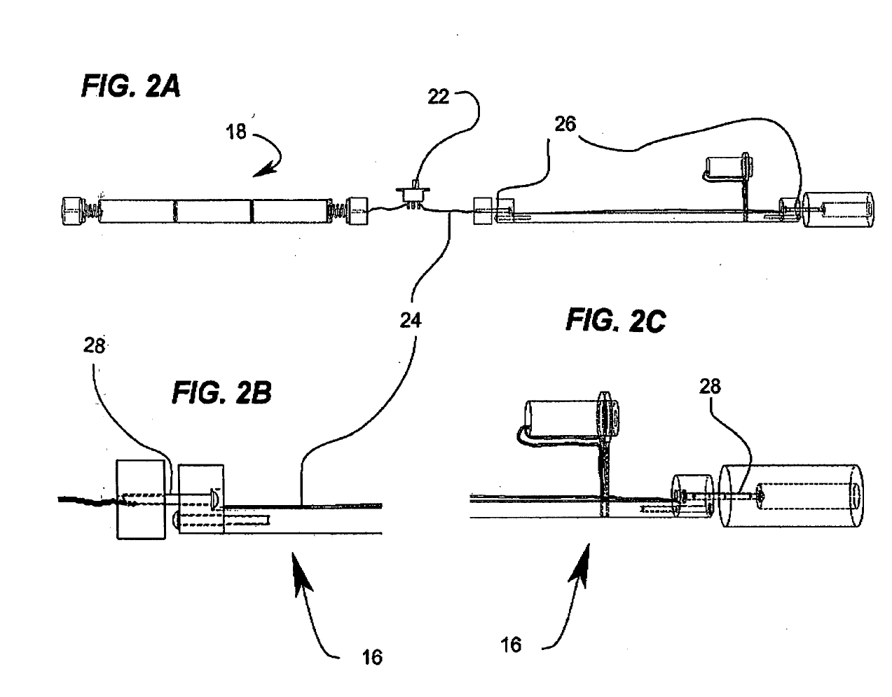

### DETAILED DESCRIPTION

A laser equipped billiard cue (10) for use on a billiard table (11), has a laser emitter module (14), a leveling member (16), and battery pack (18). The leveling member (16) is further comprised of pivots (28) and a counterweight (30)

The laser emitter module (14) projects a line that shows the intended trajectory of a ball (13). The leveling member (16) ensures that the module (14) is always straight over the top and center of the cue (10) so that the line is property aligned.

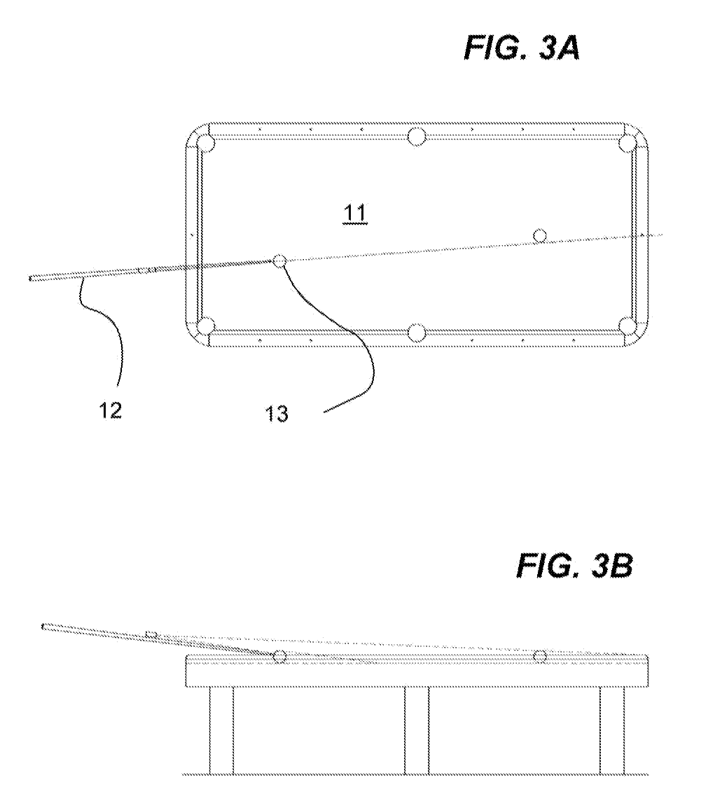

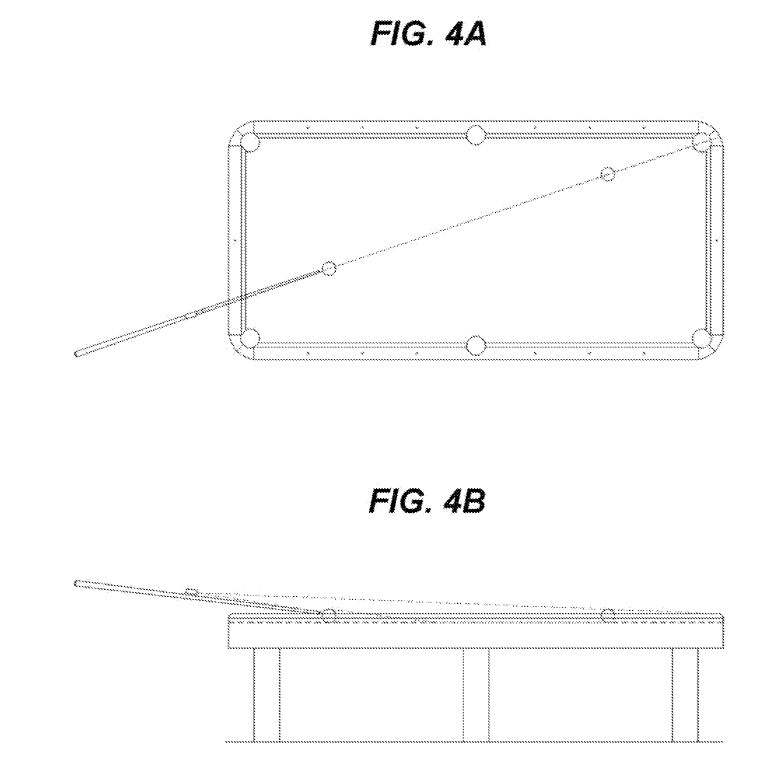

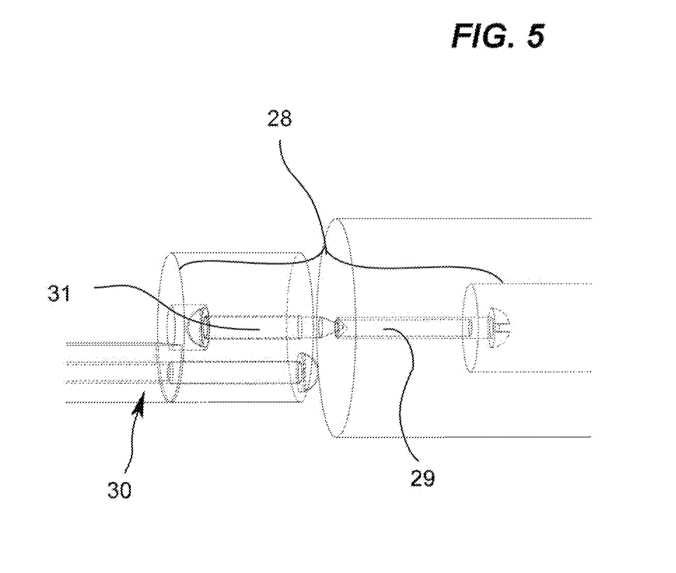

The line can light up a rug part (20) of the table (11) as well as draw a line on the ball (13) as per FIG. 3a, or skimming the ball (13) as per FIG. 4a.

The counterweight (30) has a mass which, by gravity, brings it downward by rotating a round the pivot (28). This rotation always keeps the laser emitter module (14) in an upright position above the cue (10). Since the billiard cue (10) comes in separate parts, electrical continuity between the parts is by way of the pivot (28) which consists in a fixed part (29) and a rotating part (31), both being electrically connected as well a rotationally connected. In this way, electricity can transfer between the battery pack (18) and the laser emitter module (14) by way of an ON/OFF switch (22) and wiring (24).

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A laser equipped billiard cue comprising a laser emitter module, a leveling member, and battery pack; said leveling member further comprised of a pivot member and a counterweight; said level unit being used for keeping said emitter module over the top and center of said billiard cue.

2. A laser equipped billiard cue as in claim 1 wherein said billiard cue is separable into a plurality of parts.

3. A laser equipped billiard cue as in claim 1 wherein each of said plurality of parts is electrically connected to the other by way of pivot members, and each said pivot member consisting of a fixed part and a rotating part.

4. A laser equipped billiard cue as in claim 1 wherein said laser emitter module has an ON/OFF switch.

5. A laser equipped billiard cue for use in combination with a billiard ball on a billiard table comprising a laser emitter module, a leveling member, and battery pack; said leveling member further comprised of a pivot member and a counterweight; said level unit being used for keeping said emitter module over the top and center of said billiard cue.

6. A laser equipped billiard cue for use in combination with a billiard ball on a billiard table as in claim 5 wherein said billiard cue is separable into a plurality of parts.

7. A laser equipped billiard cue for use in combination with a billiard ball on a billiard table as in claim 5 wherein each of said plurality of parts is electrically connected to the other by way of pivot members, and each said pivot member consisting of a fixed part and a rotating part.

8. A laser equipped billiard cue for use in combination with a billiard ball on a billiard table as in claim 5 wherein said laser emitter module has an ON/OFF switch.
